(19) United States
(12) Patent Application Publication
(10) Pub. No.: US 2009/0282959 A1
(43) Pub. Date: Nov. 19, 2009

(54) METHOD FOR REMOVING FLOOR FROM A SUBSTRATE

(76) Inventor: Douglas C. Willis, Washington C.H, OH (US)

Correspondence Address: STANDLEY LAW GROUP LLP, 6300 Riverside Drive, Dublin, OH, 43017, US

(21) Appl. No.: 12/466,448

(22) Filed: May 15, 2009

Related U.S. Application Data
(60) Provisional application No. 61/053,575, filed on May 15, 2008.

(51) Int. Cl. B26D 3/28; B26D 7/08

(52) U.S. Cl. 83/14; 83/17; 83/34

(57) ABSTRACT

A method for removing flooring from a substrate. A blade is forced between the flooring and substrate and is pneumatically actuated to separate the flooring from the substrate. The blade and actuating elements are contained in a tool having a handle and rolling means for facilitating movement such that the tool can be easily moved horizontally. The removed flooring may be directed towards the front of the tool so that the removed flooring can be easily disposed of. The blade may rotate, move vertically, or any combination of the two. The blade's precise movement is defined by linkages between a pneumatic cylinder and the blade.

### CROSS-REFERENCE TO RELATED APPLICATIONS

This application claims priority to co-pending application No. 61/053575 filed on May 15, 2008, which is incorporated by reference as if cited fully herein.

### TECHNICAL FIELD

The disclosed embodiments relate to a method and apparatus for removing flooring.

### BACKGROUND

A common process during construction/remodeling projects is the removal of an existing floor covering from a substrate. Typically, this can be a very time-consuming project involving extensive manual labor.

### BRIEF SUMMARY

Exemplary embodiments include methods and apparatus for removing flooring materials and surface coverings, including but not limited to: carpet, VCT, vinyl, ceramics, luan, pergo, tile, hardwoods, elastomerics, epoxies, decorative coatings, sport courts and many other surface coverings and flooring materials.

Exemplary embodiments utilize a blade which is actuated by a pneumatic device with various linkages and plates. The blade may rotate, raise and lower vertically, or perform a combination of both, in order to lift the flooring material for removal. The specific combination and design of the pneumatic device, linkages, and plates varies widely based on the desired movement of the blade relative to the flooring material.

The blade may be relatively large or small depending on the amount of flooring material to be removed and the work space which is available. The pneumatic device may be powered by a separate compressor, or may contain an on-board compressor.

The linkages, plates, and exhaust from the pneumatic device can be used alone or in combination to force the removed flooring material into a specific orientation to aid in its collection and disposal.

These and other advantages of the preferred embodiments are further described below.

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1 is a front elevation view of an exemplary device for conducting a rotational embodiment;

FIG. 2 is an illustration of a first rotational embodiment;

FIG. 3 is an illustration of a second rotational embodiment; and

FIG. 4 is an illustration of a vertical embodiment.

### DETAILED DESCRIPTION

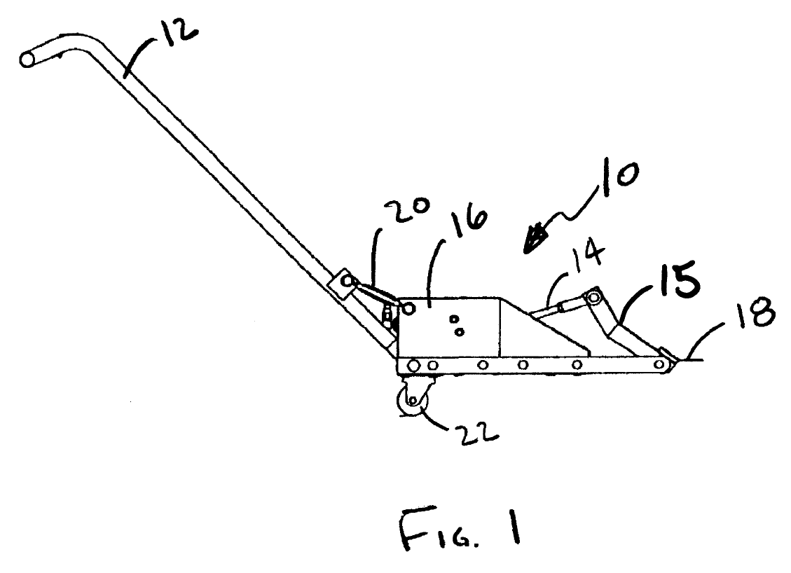

Turning to the drawings for a better understanding, FIG. 1 shows an exemplary device for performing a rotational embodiment. In this embodiment, the handle 12 is attached to the housing 16 by means of an adjustable turn buckle 20. The turn buckle 20 allows the handle 12 to attach to the housing 16 at various angles, in order to accommodate users at different heights or users requiring a different amount of leverage at the blade 18.

The mechanism 10 for performing embodiments of the methods comprises the housing 16 which partially contains a pneumatic device with a pneumatic actuator 14, an arrangement of linkages and plates 15 which are attached to the pneumatic actuator 14, and a blade 18 which is attached to the arrangement of linkages and plates 15. The specific arrangement of linkages and plates will vary depending on the specific application of the device and whether a rotational embodiment, vertical embodiment, or combination of the two is being performed.

A rolling means 22 allows the mechanism 10 to travel along the flooring surface or the substrate beneath the flooring surface. As an example, wheels, a single caster, or multiple casters may be used as the rolling means 22.

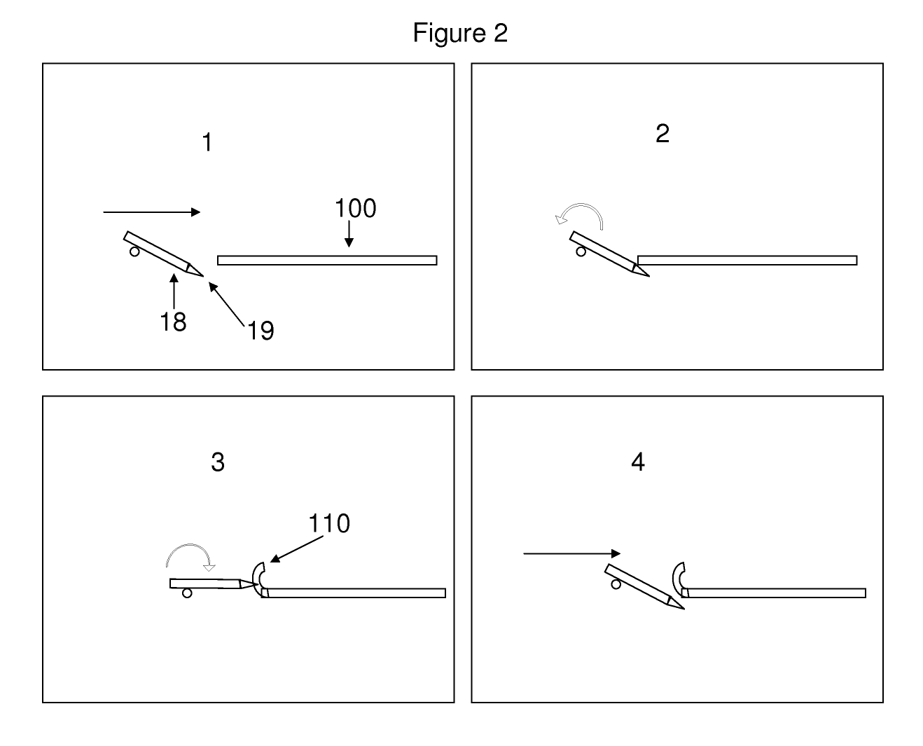

FIG. 2 shows four steps of a first rotational embodiment where the blade 18 rotates about a point that is located somewhere along the length of the blade 18. A flooring surface 100 is placed atop some flooring substrate (not shown). In the first step, the blade 18 is located in its starting position (also known as a first position) and is moved horizontally towards the edge of the flooring surface 100, so that the edge of the blade 18 is located underneath the edge of the flooring surface 100 at the completion of the step. In the second step, the blade 18 is rotated counter-clockwise (or into a second position) so as to lift the flooring surface 100. This rotation is accomplished by the pneumatic actuator 14 and the arrangement of linkages and plates 15. In step three, the blade 18 is rotated clockwise, back to the starting position (or first position) of step 1. This rotation is also accomplished by the pneumatic actuator 14 and the arrangement of linkages and plates 15. Finally, in step four, the process is repeated whereby the blade 18 is again moved horizontally towards the flooring surface 100, so that the edge of the blade 18 is located underneath the edge of the flooring surface 100 at the completion of the step.

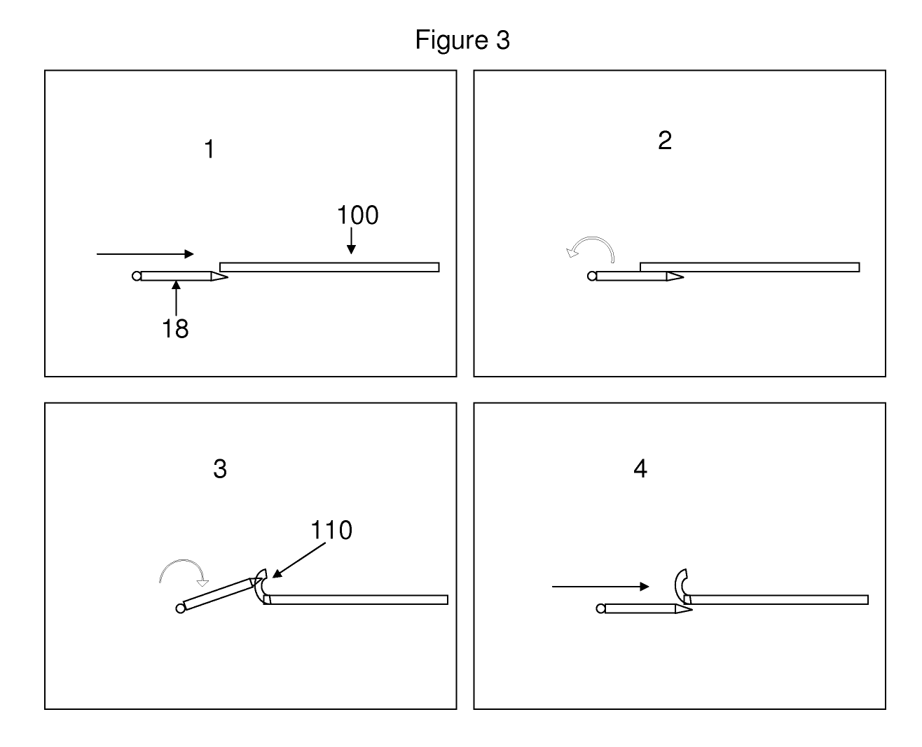

FIG. 3 shows four steps of a second rotational embodiment where the blade 18 rotates about a point that is located near the end of the blade 18. In this first step, the blade 18 is located in its starting position and is moved horizontally towards the edge of the flooring surface 100, so that the edge of the blade 18 is located underneath the edge of the flooring surface 100 at the completion of the step. In the second step, the blade 18 is rotated counter-clockwise so as to lift the flooring surface 100. This rotation is accomplished by the pneumatic actuator 14 and the arrangement of linkages and plates 15. In step three, the blade 18 is rotated clockwise, back to the starting position of step 1. This rotation is also accomplished by the pneumatic actuator 14 and the arrangement of linkages and plates 15. Finally, in step four, the process is repeated whereby the blade 18 is again moved horizontally towards the flooring surface 100, so that the edge of the blade 18 is located underneath the edge of the flooring surface 100 at the completion of the step.

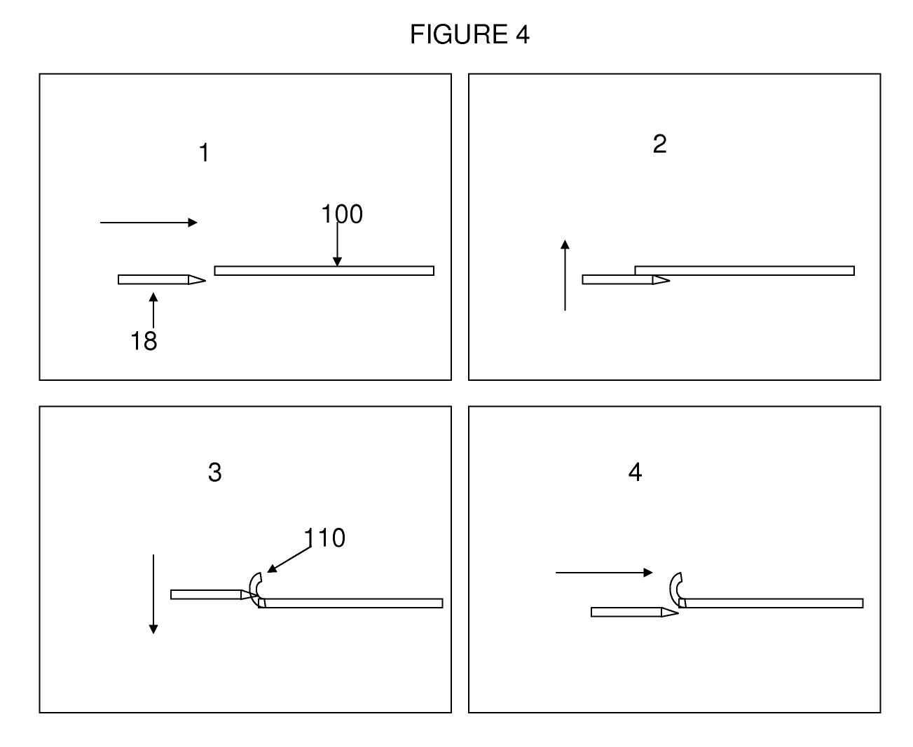

FIG. 4 shows four steps of a vertical embodiment. In the first step, the blade 18 is located in its starting position and is again moved horizontally towards the edge of the flooring surface 100. In the second step, the blade 18 is held substantially horizontal and raised vertically so as to lift the flooring surface 100. This vertical raising is accomplished by the pneumatic actuator 14 and the arrangement of linkages and plates 15. Clearly, this arrangement of linkages and plates 15 would be different than the arrangement that is used for either of the rotational embodiments found in FIGS. 2 or 3. In step three, the blade 18 is lowered vertically while holding the blade substantially horizontal, arriving back to the starting position of step 1. This lowering is again accomplished by the pneumatic actuator 14 and the arrangement of linkages and plates 15. Finally, in step four, the process is repeated whereby the blade 18 is again moved horizontally towards the flooring surface 100, so that the edge of the blade 18 is located underneath the edge of the flooring surface 100 at the completion of the step.

It should be noted that further embodiments can be generated which combine both the rotational and vertical embodiments. These further embodiments are generated based on the specific combination of linkages and plates 15 which would accomplish the desired amount of vertical translation and rotation. The mechanism 10 may be modified in many ways in order to accommodate the precise amount of translation and rotation that is required by the blade 18. These requirements may vary based on the specific type and amount of flooring material that is to be removed. The pneumatic device and actuator 14 may be reoriented or multiple actuators may be used.

Furthermore, the blade 18 may take on various shapes. One exemplary embodiment of a blade would simply comprise a thin rectangle, whereby the rectangle is thin enough to be forced underneath the flooring surface 100. Another exemplary embodiment of a blade 18 would comprise a thicker rectangle with a beveled edge on the portion of the blade that is to slide underneath the flooring surface. The beveled edge allows for the blade 18 to be thicker, but still able to slide underneath the flooring surface 100. This beveled edge may be one solid edge running the entire length of the blade 18 where it interfaces the flooring surface 100, or it may comprise a series of beveled edges or teeth-like structures.

FIGS. 2 and 3 also show the removed flooring material 110. This material can be directed using the combination of linkages and plates 15. For example, the linkages and plates 15 may direct the removed flooring material 110 so that this material stays forward of the housing 16 so that the removed flooring material 110 can be easily collected for disposal and will not interfere with the operation of the device. To further facilitate this process, the exhaust for the pneumatic device may be directed towards the front of the mechanism 10 so that the removed flooring material 110 will be forced to stay ahead of the device and may be easily collected for disposal.

The above describes the preferred embodiments of the invention. It is understood, that these embodiments are meant to be exemplary and not limiting. Various modifications and additions to the above embodiments will be apparent to those of ordinary skill in the art. It is the intention therefore to limit the invention only by the claims.

What is claimed is:

1. A method for removing flooring comprising the steps of:
A. providing a floor removal tool having a pneumatic-actuated blade;
B. moving the blade horizontally until at least a portion of the blade is underneath the flooring; and
C. actuating the blade to produce an upward force on the flooring.

2. The method of claim 1 further comprising the steps of:
D. de-actuating the blade; and
E. repeating steps B through D for additional flooring while directing the removed flooring material towards the portion of the tool containing the blade.

3. A method for removing flooring placed atop a substrate, comprising the steps of:
A. providing a floor removal tool having a blade in a starting position;
B. moving the blade horizontally until at least a portion of the blade is between the flooring and the substrate while maintaining the blade in its starting position; and
C. pneumatically-actuating the blade to a second position thereby separating a portion of the flooring from the substrate.

4. The method of claim 3 further comprising the steps of:
D. pneumatically-actuating the blade to the starting position;
E. repeating steps B through D for additional flooring.

5. A method for removing flooring from a substrate comprising the steps of:
A. providing a floor removing tool comprising:
a handle,
a housing connected to the handle,
a rolling means associated with the housing,
a blade extending from the housing, and
a pneumatic cylinder at least partially within the housing and connected to the blade in order to move the blade between a first and second position;
B. pressing horizontally on the handle in order to force the blade between a first portion of the flooring and the substrate while keeping the blade in the first position;
C. moving the blade into the second position by actuating the pneumatic cylinder and thereby separating the first portion of the flooring from the substrate and producing removed flooring material; and
D. returning the blade into the first position by actuating the pneumatic cylinder.

6. The method from claim 5 further comprising the step of:
contacting the rolling means with the substrate to facilitate the horizontal movement of the floor removal tool.

7. The method from claim 5 further comprising the steps of:
repeating steps B through D for a second portion of the flooring.

8. The method from claim 5 further comprising the steps of:
repeating steps B through D for additional flooring while directing the removed flooring material towards the blade.
